(19) United States
(12) Patent Application Publication
(10) Pub. No.: US 2023/0316133 A1
(43) Pub. Date: Oct. 5, 2023

(54) DEVICE CONTROL VALUE GENERATION APPARATUS, DEVICE CONTROL VALUE GENERATION METHOD, PROGRAM, AND LEARNING MODEL GENERATION APPARATUS

(71) Applicant: Nippon Telegraph and Telephone Corporation, Tokyo (JP)

(72) Inventors: Hikotoshi NAKAZATO, Musashino-shi, Tokyo (JP); Kenji ABE, Musashino-shi, Tokyo (JP)

(21) Appl. No.: 18/024,723

(22) PCT Filed: Sep. 9, 2020
(86) PCT No.: PCT/JP2020/034152

§ 371 Date: Mar. 3, 2023

(51) Int. Cl. G06N 20/00

(52) U.S. Cl. CPC G06N 20/00

(57) ABSTRACT

This device control value generation device comprises: a control value generation unit that generates a device control value for a plurality of control target devices; a learning data management unit that acquires items of learning data represented by the device control values and scores, and stores the same in a learning data DB for each device control factor pattern, which represent the device control values in accordance with the division range of external factors; a situation classification unit that extracts the external factor influencing a reward fluctuation and defines classifications; and a learning model management unit that uses learning data for each defined classification and generates a learning model of each classification by means of carrying out reinforcement learning such that a prescribed reward is fulfilled.

### TECHNICAL FIELD

The present invention relates to a device control value generation device, a device control value generation method, a program, and a learning model generation device that generate device control values by reinforcement learning.

### BACKGROUND ART

A technique for classifying an abnormal state by a DNN (Deep Neural Network) using only learning data of a normal state for detecting an abnormal state of a system has been published (see, for example, PTL 1).

According to the technique of PTL 1, when the tendency of the normal state changes in time series, the learning model is reconstructed only with the learning data for a certain period from the latest. Furthermore, in order to respond to changes in the tendency of “normal outliers” such as temporary high load, the learning model can be used to reconstruct with normal outliers limited to the type of singular data from the data of the latest fixed period.

### CITATION LIST

### Patent Literature

[PTL 1] WO 2019/138655

### SUMMARY OF INVENTION

### Technical Problem

On the other hand, the reward (score) in reinforcement learning may fluctuate greatly because of change in the external situation measured as an environment (hereinafter referred to as “disturbance”). The technique described in PTL 1 reconstructs a learning model assuming time-series changes in the system state value itself, but disturbances caused by a factor affecting the fluctuation of the system state value are not considered.

In addition, the factors that change the reward (score) in conventional reinforcement learning (“external factors” described later) must be manually specified, and it is also necessary to manually define the range of the specific factor as “situation” (Situation).

Furthermore, in the operation stage, if a situation occurs in which the target reward (score) is not met due to an unconsidered disturbance, countermeasures against the disturbance such as redefining the “situation” (Situation) and updating the learning model are also had to be performed manually.

The present invention was made in view of such a point, and the present invention automatically extracts the disturbance constituent factors (external factors) that give fluctuations to the reward (score) in reinforcement learning, and also the disturbance constituent factors, and the task is to update the learning model by automatically defining the “situation” (Situation) based on the above. As a result, it is possible to generate an optimum device control value for responding to a disturbance and satisfying a predetermined reward without human intervention.

### Solution to Problem

A device control value generation device according to the present invention, which generates device control values of a plurality of control target devices, is a device control value generation device, comprising:
a situation recognition unit that acquires data from each IoT device, determines an external factor according to a type of the IoT device, and determines to which division range obtained by dividing an upper limit value and a lower limit value of the determined external factor into a predetermined range the acquired data belongs;
a control value generation unit that generates the device control value according to a value of data of each external factor for each of the division ranges;
a device control unit that transmits the device control value to each control target device;
a score calculation unit for calculating a score indicating a reward obtained from a control result of each control target device;
a learning data management unit that stores each learning data indicated by the device control value and the score as a control result thereof in a learning data DB for each device control factor pattern indicating the device control value corresponding to the division range of each external factor, a situation classification unit that
acquires the learning data, which is only changed a specified external factor, after one of external factors is specified, and other external factors excluding the external factor, and the device control factor pattern are fixed, from the learning data DB,
extracts the score of the learning data,
calculates a predetermined impurity of the specified external factor by determining which of divided classes divided into predetermined classes according to a level of the score, calculates the impurity in the same device control factor pattern for each of the external factors,
extracts top N external factors having the calculated large impurity,
extracts P external factors in descending order of sum of the number of appearances from the top N external factors extracted in a predetermined M or more device control factor patterns to be a constitution element of a situation as a factor affecting reward variation,
divides extracted each value of P external factors into predetermined Q range widths,
constitutes a decision tree that branches in the order of extraction, constituted decision tree, and
defines each of final branch points in the constructed decision tree as a classification that is one of the situations; and
a learning model management unit that generates a learning model for each of the classifications by performing reinforcement learning so as to satisfy a predetermined reward using the defined learning data for each of the classifications, wherein
the learning model management unit collects learning data by generating the device control value and updates the learning model for each classification, until the predetermined reward is satisfied.

### Advantageous Effects of Invention

According to the present invention, a disturbance component factor that fluctuates a reward (score) in reinforcement learning is automatically extracted, and a “situation” (Situation) is automatically defined based on the disturbance component factor for learning, and learning model can be updated. As a result, it is possible to generate an optimum device control value for responding to a disturbance and satisfying a predetermined reward without human intervention.

### BRIEF DESCRIPTION OF DRAWINGS

FIG. 1

It is a figure explaining the target vehicle tracking system as an example of this embodiment.

FIG. 2

It is a figure for explaining “situation” (Situation) and “device control factor” as a factor which influences a reward (score) fluctuation.

FIG. 3

It is a block diagram which shows the structure of the device control value generation device which concerns on this embodiment.

FIG. 4

It is a block diagram which shows the structure of the reinforcement learning part (learning model generation device) which concerns on this embodiment.

FIG. 5

It is a figure for demonstrating the “situation” (Situation) definition process which concerns on this embodiment.

FIG. 6

It is a figure for demonstrating the “situation” (Situation) definition process which concerns on this embodiment.

FIG. 7

It is a figure for demonstrating the definition of “situation” (1Situation) by the construction of the decision tree which concerns on this embodiment.

FIG. 8

It is a flowchart which shows the flow of the “situation” (Situation) definition process executed by the device control value generation device which concerns on this embodiment.

FIG. 9

It is a flowchart which shows the flow of the review process of the “situation” (Situation) definition executed by the device control value generation device which concerns on this embodiment.

FIG. 10

It is a flowchart which shows the flow of the location characteristic update process executed by the device control value generation device which concerns on this embodiment.

FIG. 11

It is a flowchart which shows the flow of the change monitoring processing of the location characteristic executed by the device control value generation device which concerns on this embodiment.

FIG. 12

It is a hardware configuration diagram which shows an example of the computer which realizes the function of the device control value generation device which concerns on this embodiment.

### DESCRIPTION OF EMBODIMENTS

Next, an embodiment for carrying out the present invention (hereinafter referred to as “the present embodiment”) will be explained. First, in the present invention, the factors that influence the fluctuation of the reward (score) in reinforcement learning are defined.

In this embodiment, two factors, “situation” (Situation) and “device control factor”, are defined as factors that influence the fluctuation of the reward (score).

“Situation” (Situation) is further classified into “external factors” and “location characteristics”.

The “external factor” refers to a factor that is known to have a possibility of influencing fluctuations in reward and whose value can be measured by a measuring instrument or the like. There are some factors affecting the variation of the reward and those not affecting the variation of the reward, and in the case of defining the “Situation” (Situation), an external factor affecting the influence is handled.

“Location characteristics” are factors other than external factors that affect unknown or unmeasured (unmeasurable) reward fluctuations. There is a specific location characteristic pattern for each specific environment (location). However, it is also a factor that is hidden and does not need to be considered when determining the optimum device control value by reinforcement learning in an individual environment.

The “device control factor” is information indicating a control value (for example, List type) in each device of the device group to be controlled (“control target device group” described later). Control value in each device (hereinafter referred to as “device control value” may be regarded as the same category for each predetermined range width, and may constitute a device control factor.

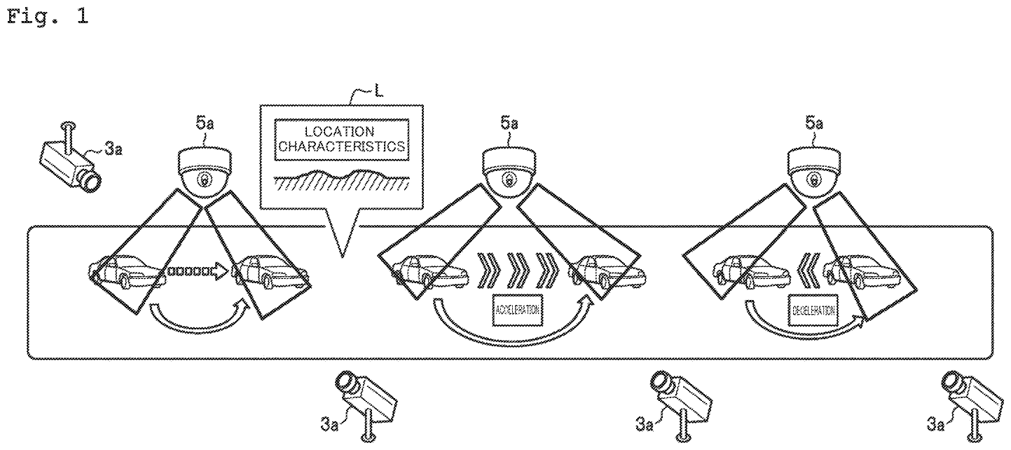

As an example of this embodiment, in a certain course (start point to end point), a case of generating a device control value for tracking (capturing) a vehicle to be moved by a camera device (swing camera 5a) (hereinafter referred to as “target vehicle tracking system” will be described with reference to FIG. 1. Here, the reward (score) set in reinforcement learning is the total time required for the target vehicle to pass the course of the tracking section, and the time during which the vehicle can be captured by any of the camera devices. That is, the longer the time that any camera device (swing camera 5a) captures the target vehicle throughout the course of the tracking section, the higher the score.

The device control value (device control factor) calculated by reinforcement learning is, for example, the rotation direction of the camera device, which is the swing camera 5a, and the specified angle (the angle specified when starting the rotation for tracking the target vehicle), and a rotation start time (time from setting to the specified angle to the start of rotation after that), and the like.

The external factor is, for example, the speed of the vehicle. When the constitution element of the “situation” (Situation) is the speed of the vehicle, the “situation” (Situation) is classified according to a predetermined range width. For example, the Situation “A” is set to a speed of 0 to 15 km, the Situation “B” is set to a speed of 16 to 30 km, and the Situation “C” is set to a speed of 31 to 45 km.

In the example shown in FIG. 1, the speed of the vehicle is measured by the fixed camera 3a, “situation” (Situation) is specified by using the speed information, and each swing camera 5a is controlled by setting the device control value (in this case, the rotation direction, the specified angle, the rotation start time, and the like) corresponding to “situation” (Situation) (for example, when the speed of the vehicle is 20 km, the speed of the Situation “B” is 16 km to 30 km). Then, the control result (here, the ratio of the time captured by the camera device to the time when the vehicle passes the course) is calculated as a reward (score).

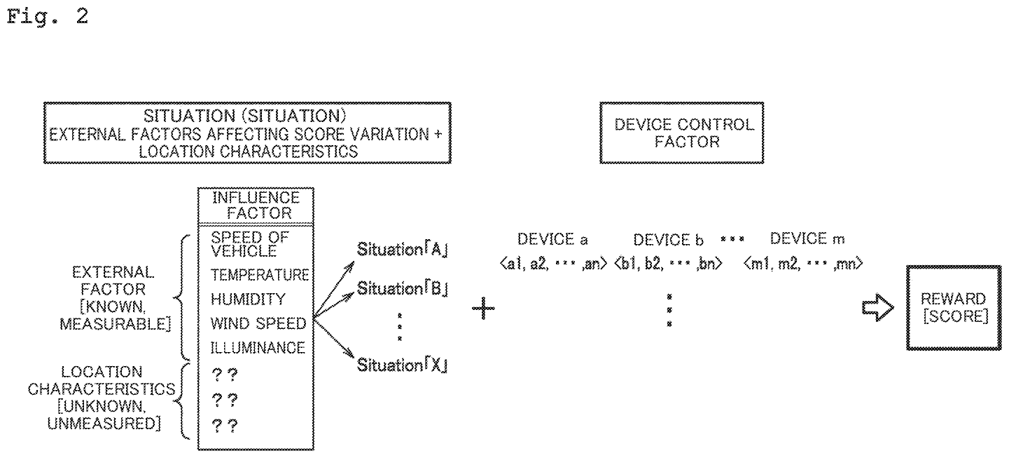

In the example described in FIG. 1, the external factor is described only by the speed of the vehicle. However, in fact, factors that influence the reward fluctuation are not only the speed of the vehicle, for example, but also known measurable factors such as the temperature, humidity, wind speed for detecting the generation of fog on the road, and illuminance affecting nighttime shooting as shown in FIG. 2. In addition, as unknown and unmeasured location characteristics, for example, may be installation on a road of a “hump” (steps or bumps) for lowering the speed of a traveling vehicle (see reference sign L in FIG. 1), installation of curb extensions to narrow the width of the road, and influence of growth of trees on driving around roads.

The device control factor of each device is set for each “situation” (Situation) determined by the external factors and location characteristics that affect these score fluctuations, and the reward (score) is calculated.

The present invention is not limited to the target vehicle tracking system shown in FIGS. 1 and 2, and may be any system that performs Inter-device cooperative control in an individual environment utilizing reinforcement learning. For example, it can be applied to various systems such as a cooling system of a data center, a robot automatic transportation system in a factory, and an irrigation water amount adjustment system in a farmhouse.

In a cooling system of a data center, as external factors, temperature around each server, outside air temperature, power consumption of the server, Information such as the operation efficiency of the server is acquired, and the total power consumption is equal to or less than a predetermined value, and the temperature is lowered by X degrees or more within a time t in the area, or the like, as a target reward. The device to be controlled at this time is an air conditioner, and the device control factor (device control value) is an air volume, a target temperature, a wind direction, and the like.

In the robot automatic transportation system in the factory, as an external factor, the target reward is to acquire information such as camera images of each robot and to accurately transport all the luggage to the line in a shorter time. The device to be controlled at this time is a transport robot, and the device control factor (device control value) is the speed of the robot, the motor rotation speed, the brake strength, and the like.

In the irrigation water amount adjustment system in farmers, information such as temperature, humidity, sunshine quantity, soil water content, soil quality, amount of rainfall, and plant growth condition identified from images is acquired from sensors set on the farmland as external factors, however, the target reward is that the soil water content is equal to or higher than the predetermined value and the final yield is equal to or higher than the predetermined value. At this time, the device to be controlled is a compost robot, and the device control factor (device control value) is the amount of water, the amount of compost, and the like.

As described above, the present invention is applicable as long as it is a system that performs cooperative control between devices in an individual environment utilizing reinforcement learning, but the target vehicle tracking system will be described below as an example.

A device control value generation device 1 according to the present embodiment automatically extracts a disturbance component factor (external factor) that fluctuates the reward (score) in reinforcement learning, and “situation” (Situation) based on the disturbance component factor. Situation) is automatically defined. Furthermore, it detects changes in location characteristics that are unknown and unmeasured, updates the learning model, and automatically generates the optimum device control value that satisfies a predetermined reward (score).

Hereinafter, a specific configuration of the device control value generation device 1 will be described.

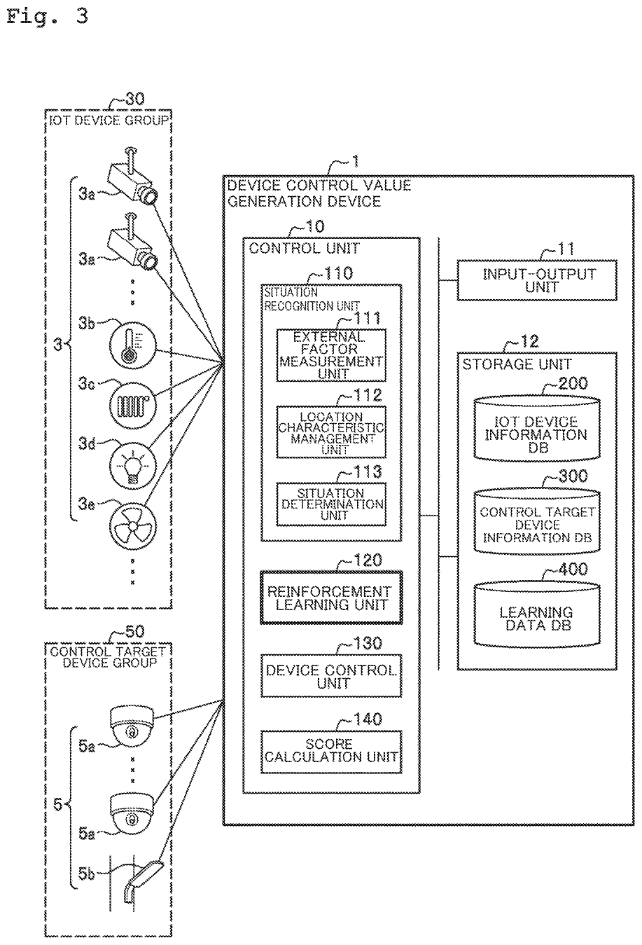

FIG. 3 is a block diagram showing a configuration of the device control value generation device 1 according to the present embodiment.

The device control value generation device 1 is communicatively connected to an IoT device 3 such as a camera device (fixed camera 3a) and various sensor devices (for example, a temperature sensor 3b, a humidity sensor 3c, an illuminance sensor 3d, and an anemometer 3e). Then, the device control value generation device 1 uses the information from these IoT devices 3 to generate a device control value by reinforcement learning so that the reward (score) becomes a predetermined value (target reward) or more, and communicates, and the connected control target device 5 is controlled. In the example of the target vehicle tracking system, the control target device 5 is a swing camera 5a, a lighting device 5b (street light), or the like. In the present embodiment, the control target device 5 will be described as a swing camera 5a arranged along the course.

The device control value generation device 1 includes a control unit 10, an input-output unit 11, and a storage unit 12.

The input-output unit 11 inputs and outputs information between each IoT device 3 of the IoT device group 30 and each control target device 5 of the control target device group 50. The input-output unit 11 is composed of a communication interface through which information is transmitted and received via a communication line, and an input-output interface through which information is input to and output from an input device such as a keyboard (not shown) and an output device such as a monitor.

The storage unit 12 is composed of a hard disk, a flash memory, a RAM (Random Access Memory), and the like.

As shown in FIG. 3, the storage unit 12 stores an IoT device information DB 200, a control target device information DB 300, and a learning data DB 400. Further, the storage unit 12 temporarily stores a program for executing each functional unit of the control unit 10 and information necessary for processing of the control unit 10.

The IoT device information DB 200 stores information on the type of the IoT device 3, and information on the installation position, in association with the identification information of each IoT device 3.

Further, in this IoT device information DB 200, for each type of IoT device 3, the upper limit value/lower limit value of the external factor which is the information that can be acquired from the IoT device 3, and the class, which is a divided range of the range indicated by the upper limit value/lower limit value divided by N, is stored in advance. This division range is tentatively set in the initial learning stage (details will be described later) for acquiring learning data.

The control target device information DB 300 stores information on the type of the control target device 5 and information on the placement position in association with the identification information of each control target device 5. The control target device information DB 300 manages a group of control target device group 50 related to the calculation of the reward (score) as a spot. A plurality of spots may be stored in the control target device information DB 300.

In the learning data DB 400, the device control value for each control target device 5 generated by the device control value generation device 1 and the reward (score) when the control target device 5 is controlled by the device control value are stored as learning data. In this learning data, the device control value of each control target device 5 is stored as a device control factor pattern for each class of “situation” (Situation) set by the device control value generation device 1.

The control unit 10 controls the overall processing executed by the device control value generation device 1, and includes a situation recognition unit 110, a reinforcement learning unit 120, a device control unit 130, and a score calculation unit 140.

The situation recognition unit 110 acquires data from each IoT device 3 of the IoT device group 30. Then, the situation recognition unit 110 determines the range for each external factor based on the value of each data, and determines the “situation” (Situation). The situation recognition unit 110 includes an external factor measurement unit 111, a location characteristic management unit 112, and a situation determination unit 113.

The external factor measurement unit 111 acquires data from each IoT device 3. This data is accompanied by identification information of each IoT device 3 together with measured values of external factors (for example, speed of the vehicle, temperature, humidity, etc.) measured by each IoT device 3.

The location characteristic management unit 112 refers to the IoT device information DB 200 based on the identification information attached to the data acquired by the external factor measurement unit 111, and determines which is information belongs to reinforcement learning about a spot of a location (specific environment). In the following description, the above-mentioned target vehicle tracking system at a spot, which is a certain location (specific environment), will be mainly explained as an example.

In the initial learning stage, the situation determination unit 113 identifies a class of the division range of the external factor stored in the IoT device information DB 200 based on the value of the data acquired by the external factor measurement unit 111. The “initial learning stage” refers to a stage before the definition of “situation” (Situation) (extraction and classification of constitution elements) by the reinforcement learning unit 120 (situation classification unit 122) described later. Further, when the term “learning stage” is simply described, it means a stage in which “situation” (Situation) is defined and reinforcement learning is performed using learning data.

The situation determination unit 113 determines to which of the classified “situations” (the “situation” (1Situation) described later) the relevant data belongs in the “situation” (Situation) defined by the reinforcement learning unit 120 (situation classification unit 122) based on the value of the data acquired by the external factor measurement unit 111 in the learning stage and the operation stage after satisfying a predetermined reward (score).

The reinforcement learning unit 120 extracts an external factor having a large influence on the increase/decrease of the reward (score) as an influence factor (constitution element) of the “situation” (Situation). Then, the reinforcement learning unit 120 performs class classification each external factor of the “situation” (Situation) for each predetermined range width, and generates a device control value of each control target device 5.

In addition, the reinforcement learning unit 120 considers the occurrence of a continuous disturbance in which the reward (score) fluctuates significantly compared to the past for a predetermined period of time as a change in the location characteristic, and stores the learning data of the new location characteristic, and reconstruct the learning model for each “Situation”.

The reinforcement learning unit 120 updates the external factor which is the constitution element of the “situation” (Situation), for each predetermined period, and updates a learning model for each “situation” (Situation) and stores learning data again.

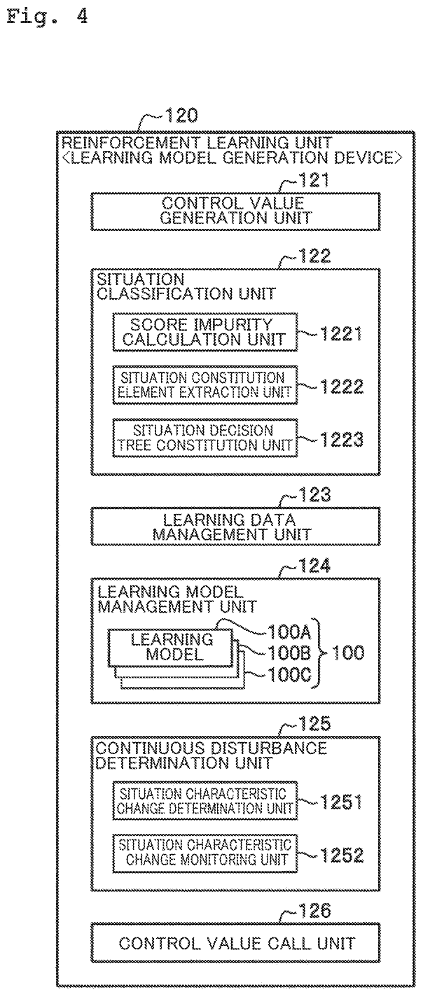

Details of the functions included in the reinforcement learning unit 120 will be described later with reference to FIG. 4.

The device control unit 130 transmits the device control value determined by the reinforcement learning unit 120 to each control target device 5 as control information. As a result, each control target device 5 executes control based on the device control value.

The score calculation unit 140 calculates a predetermined reward (score) based on the control result of each control target device 5. The score calculation unit 140 acquires information necessary for calculating a reward (score) from each control target device 5, an external management device, or the like.

Next, the function of the reinforcement learning unit 120 will be described with reference to FIG. 4.

The reinforcement learning unit 120 identifies an external factor that has a large influence on the reward (score), sets a “situation” (Situation), and performs reinforcement learning using learning data for each “situation” (Situation), and builds a learning model and generate optimal device control values.

The reinforcement learning unit 120 includes a control value generation unit 121, the situation classification unit 122, a learning data management unit 123, a learning model management unit 124, a continuous disturbance determination unit 125, and a control value call unit 126.

The reinforcement learning unit 120 may be the learning model generation device having a different housing from the device control value generation device 1.

In an initial learning stage where learning data is small, the control value generation unit 121 generate device control values associated with external factors (for example, speed of the vehicle, temperature, humidity, etc.) for each division range of each external factor specified by the situation recognition unit 110 (situation determination unit 113). At this time, the control value generation unit 121 randomly generates, for example, the control value of each control target device 5.

In the initial learning stage, the score calculation unit 140 calculates the device control value generated by the control value generation unit 121 is transmitted to each control target device 5 via the device control unit 130, and the resulting reward (score) is calculated as a score. As a result, the learning data management unit 123 stores the learning data in the learning data DB 400 in the storage unit 12.

The situation classification unit 122 refers to the same device control factor pattern (hereinafter referred to as “device control factor pattern”) under an individual environment (specific location characteristic) is used to extract external factors that have a large effect on rewards (scores) by changing specific external factors. Then, the situation classification unit 122 extracts external factors that appear in common to a plurality of device control factor patterns as constitution elements of the “situation” (Situation), and performs class classification for each constitution element for each predetermined range width.

The situation classification unit 122 includes a score impurity calculation unit 1221, a situation constitution element extraction unit 1222, and a situation decision tree constitution unit 1223.

The score impurity calculation unit 1221 specifies one external factor from among a plurality of external factors. Then, the score impurity calculation unit 1221 fixes the external factors other than the specified external factor and the device control factor pattern, and then extracts learning data in which the value of only the specified external factor is changed from the learning data DB 400. Here, “change” in the value of the external factor indicates that the external factor is shifted to a different range among divided ranges obtained by dividing the range between the upper limit value and the lower limit value of the external factor into N parts. When the learning data to be extracted is insufficient, the score impurity calculation unit 1221 may acquire additional learning data in which only the specified external factor is changed.

The score impurity calculation unit 1221 extracts the reward (score) of the learning data in which the values of the specified external factors are changed in the same device control factor pattern.

Then, the score impurity calculation unit 1221 calculates the impurity of the reward (score) of each external factor, and extracts the top N external factors having a large impurity. The reward (score) has an upper limit value and a lower limit value, and among the N divisions within this range, the score values within the division range are set to the same class. Here, the impurity is calculated, for example, by the entropy represented by the following formula (1).

$$\begin{matrix}[ Math . 1 ] & \\ {1}_{H} ( t ) = - {\sum }_{i = 1}^{c} p ( i \vert t ) {log}_{2} p ( i \vert t ) where , p ( i \vert t ) = \frac{{n}_{i}}{N} & ( Equation 1 )\end{matrix}$$

c: number of classes, t; current node, N: total number of data, nᵢ: number of data belonging to class i.

When the score impurity calculation unit 1221 has less than N external factors whose purity is equal to or higher than a predetermined threshold value, only the external factors that satisfy the requirements are extracted.

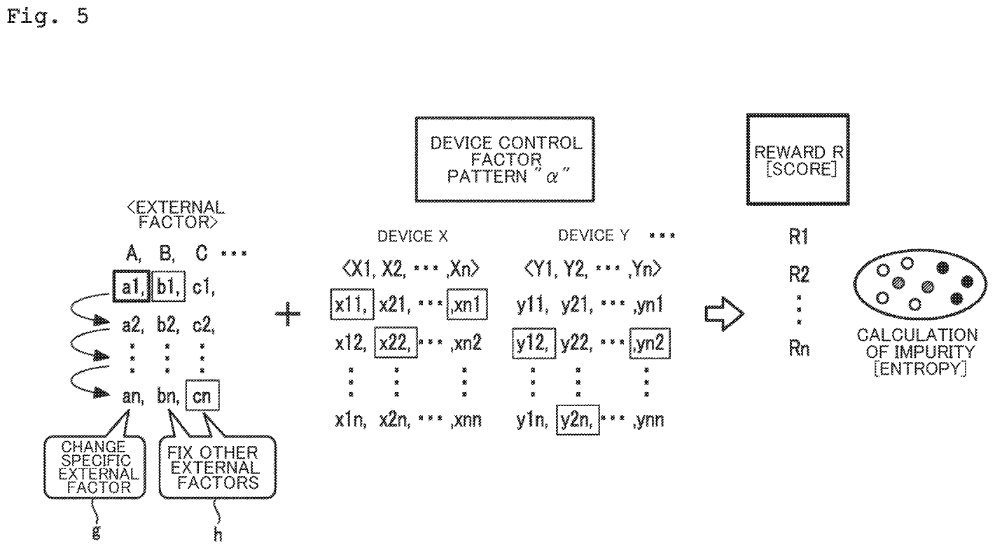

The example shown in FIG. 5 will be described. It is assumed that the score impurity calculation unit 1221 has specified the external factor “A” as the external factor that changes the value (reference sign g in FIG. 5). In this case, the other external factors “B” and “C” are fixed to, for example, the values of “b1” and “cn” (reference sign h in FIG. 5). Then, the device control factor pattern is fixed to “α”. Within the device control factor pattern “α”, each device control value is fixed to a value within the same division range.

In this way, the values other than the value of the external factor “A” are fixed, and the value “a1” of the external factor “A” is changed to the values “a2” . . . “an” of different division ranges. Then, it is determined which class (R1 to Rn) the value of the reward R (score) at that time belongs to. As a result, the score impurity calculation unit 1221 calculates the impurity (entropy) of the reward (score) for each external factor for the device control factor pattern “α”.

The score impurity calculation unit 1221 extracts external factors of a high-ranking N with a large purity in each device control factor pattern (α, β, . . . , γ) for a predetermined M or more device control factor patterns (α, β, . . . , γ).

The situation constitution element extraction unit 1222 refers to the top N external factors of each device control factor pattern extracted by the score impurity calculation unit 1221, and the number of appearances of the external factor appearing in all the extracted device control factor patterns, and P pieces are extracted in descending order of sum, and used as a constitution element of the “situation” (Situation).

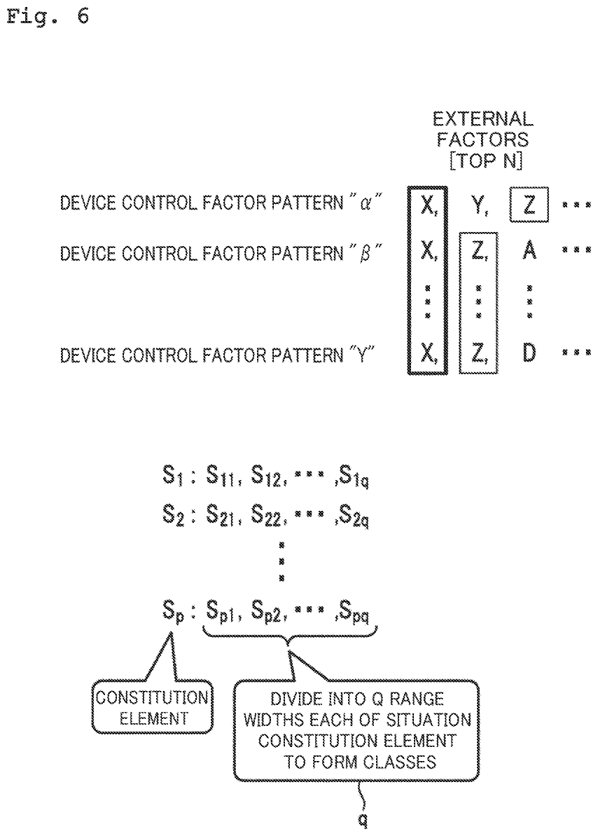

As shown in FIG. 6, for example, the upper N external factors in the device control factor pattern “α” are “X”, “Y”, “Z” . . . , and the upper N external worlds in the device control factor pattern “β”. It is assumed that the factors are “X”, “Z”, “A” . . . , and the upper N external factors in the device control factor pattern “γ” are “X”, “Z”, “D” . . . . In this case, P pieces are extracted in descending order of the total number of appearances of each external world factor appearing in the upper N external factors of all device control factor patterns, and the constitution elements (S₁, S₂, . . . , Sₚ) of the “situation” (Situation).

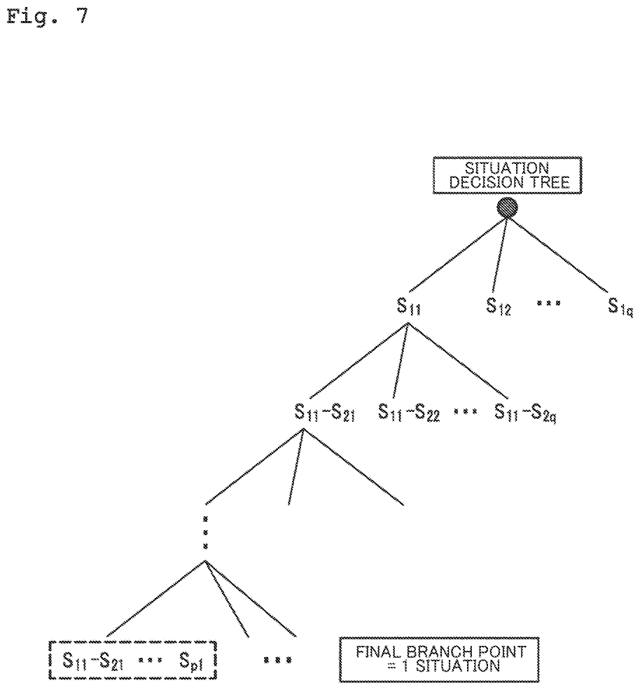

The situation decision tree constitution unit 1223 divides each of the external factors into Q range widths for the P external factors extracted by the situation constitution element extraction unit 1222 to form a class (reference sign q in FIG. 6). Then, as shown in FIG. 7, the situation decision tree constitution unit 1223 constructs a decision tree that extracts and branches classes in the order of extraction of P external factors. Then, the situation decision tree constitution unit 1223 defines the final branch point in the constructed decision tree as one “situation” (Situation), that is, as 1Situation. In the following description, it is described as “situation” (1Situation) when the individual “situation” defined by branching (classification) is intended. The “situation” (1Situation) corresponds to the “classification” described in the claims.

The situation classification unit 122 extracts and “extracts external factors that have a large influence on rewards (scores) when learning data is insufficient, which is a period when there are few variations of external factors at the start of operation, or at predetermined time intervals in the operation stage, and repeats the redefinition of the “situation” (Situation). When there is a change in the constitution elements of the “situation” (Situation), the learning model reclassifying the learning data and reconstructing the learning model for each “situation” (1Situation) are performed by the learning data management unit 123 and the learning data management unit 124.

In addition, after updating the learning model, for the “situation” (1Situation) in which the device control value predicted for the target reward (score) does not satisfy the target reward (score), generating predictive control values and updating the learning model, until the device control value that satisfies the target reward (score) is discovered.

Returning to FIG. 4, the learning data management unit 123 stored in the learning data DB 400 for each “situation” (1Situation) as learning data of the device control value generated by the control value generation unit 121 and the score calculated by the score calculation unit 140 based on the result of the device control.

The learning model management unit 124 manages a learning model 100 (100A, 100B, 100C, . . . ) of each “situation” (1Situation), which is performed reinforcement learning by using the learning data. When the constitution element of the “situation” (Situation) is changed in the situation classification unit 122, the learning model management unit 124 reconstructs the learning model for each “situation” (1Situation).

In addition, the learning model management unit 124 satisfies each predetermined target reward (score) in the construction of the learning model by reinforcement learning, so that even after the learning stage is completed and the operation stage is started, each “situation” (1Situation) acquires the device control information (device control factor pattern) summarized the device control values of the control target device 5, and the score thereof, and stores in the learning data DB 400.

In the device control factor pattern of the same “situation” (1Situation) in the operation stage, the continuous disturbance determination unit 125 updates the learning model, by assuming that a continuous disturbance occurs and the location characteristics have changed, when a period that does not meet the predetermined target reward (score) occurs for a predetermined period. In addition, when continuous disturbance occurs at a predetermined frequency, an alert is issued assuming that the disturbance of the disturbance due to an unknown external factor has occurred at the corresponding location.

The continuous disturbance determination unit 125 includes a situation characteristic change determination unit 1251 and a situation characteristic change monitoring unit 1252.

The situation characteristic change determination unit 1251 determines that a continuous disturbance has occurred and the location characteristics have changed, when the period not satisfying the predetermined target reward continues for a predetermined period T (first predetermined period) or more in the device control factor pattern in the same “situation” (1 Situation) at the operation stage. Then, the situation characteristic change determination unit 1251 deletes all the learning data of all the “situations” (1Situation) in the corresponding location before the predetermined period T via the learning data management unit 123, and updates the learning model.

After updating the learning model, generating device control values and updating the learning model are performed until the device control value that satisfies the target reward (score) is discovered for the “situation” (1Situation) that does not meet the target of the predicted device control value with respect to the target reward (score).

The situation characteristic change monitoring unit 1252 determines that disturbance fluctuation due to an unknown external factor occurs at the corresponding location, when the situation characteristic change determination unit 1251 determines that the continuous disturbance occurs and the location characteristic is changed, and when the frequency of execution of the update of the learning model during the predetermined frequency Z times (predetermined number of times) or more occurs in a predetermined period Ta (second predetermined period). Then, the situation characteristic change monitoring unit 1252 notifies an alert to, for example, an external management device or the like to increase the kinds of measuring instruments and manually classify the “situation” (Situation), when it is determined that disturbance fluctuation due to an unknown external factor occurs.

The control value call unit 126 extracts device control value (device control factor pattern) corresponded to the “situation” (1Situation) by referring to the learning data DB 400 in the storage unit 12, based on the “situation” (1Situation) determined by the situation recognition unit 110 in the learning stage and the operation stage, and output to the device control unit 130. At that time, the control value call unit 126 extracts the device control value having the highest reward (score) from the device control values (device control factor patterns) included in the “situation” (1Situation), and sends to each control target device 5. As a result, about the learning model, the parameters can be adjusted so that the reward (score) is higher by reinforcement learning.

<Processing Flow>

Next, the processing flow executed by the device control value generation device 1 according to the present embodiment will be described.

<<“Situation” (Situation) Definition Process>>

First, the “situation” (Situation) definition process executed by the device control value generation device 1 will be described.

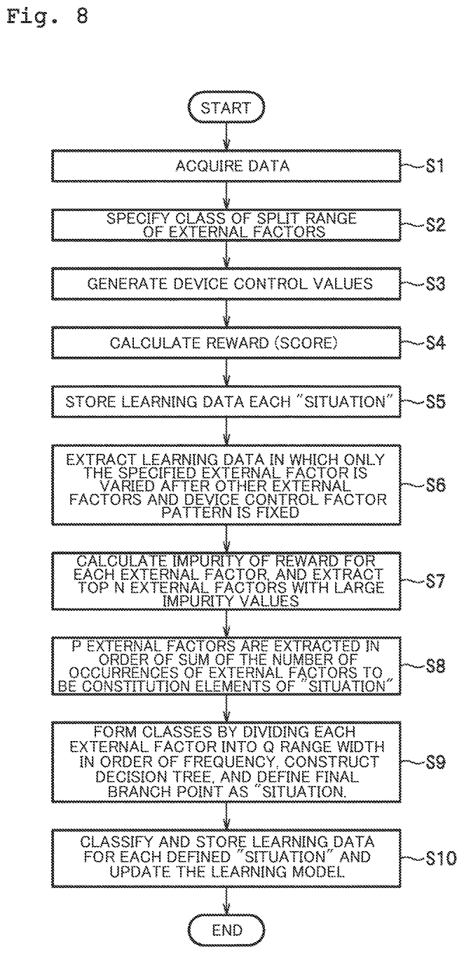

FIG. 8 is a flowchart showing the flow of the “situation” (Situation) definition process executed by the device control value generation device 1 according to the present embodiment.

First, the situation recognition unit 110 (external factor measurement unit 111) of the device control value generation device 1 acquires data from each IoT device 3 (step S1).

On the basis of the device identification information attached to this data, the situation recognition unit (location characteristic management unit 112) determines which information about spot is a location (specific environment), with reference to the IoT device information DB 200.

Next, the situation determination unit 113 of the situation recognition unit 110 identifies a class in the division range of the external factor stored in the IoT device information DB 200 based on the value of each acquired data (step S2).

Subsequently, the control value generation unit 121 of the reinforcement learning unit 120 generates a device control value associated with the measured value of the external factor (for example, speed of the vehicle, temperature, humidity, illuminance) for each division range of the external factor specified by the situation recognition unit 110 (step S3).

This device control value is generated by a method such as random number generation in order to avoid similarities between the device control values.

Then, the device control unit 130 transmits the generated device control value to each control target device 5 to execute control. Then, the score calculation unit 140 calculates the reward (score) based on the control result of each control target device 5 (step S4).

The learning data management unit 123 of the reinforcement learning unit 120 stores the generated device control value and the reward (score) as the control result by the device control value as learning data each of the “situation” (Situation) based on the class specified in step S2 (step S5).

The device control value generation device 1 repeats the processes of steps S1 to S5 until the number of learning data of each “situation” (Situation) reaches a predetermined number.

The processing up to this point is the initial learning stage, and the reinforcement learning unit 120 of the device control value generation device 1 has detected the learning data management unit 123 that the number of learning data of each “situation” (Situation) has reached a predetermined number, and with the acquisition of instruction information from an external device as an opportunity, the process proceeds to extraction and setting processing of the constitution elements of the “situation” (Situation) in step S6 and subsequent steps.

Next, the situation classification unit 122 (score impurity calculation unit 1221) of the reinforcement learning unit 120 extracts the learning data, which is only changed the specified external factor, after one of external factors is specified, and other external factors excluding the external factor, and the device control factor pattern are fixed, from the learning data DB 400 (step S6).

The score impurity calculation unit 1221 extracts learning data in which only the specified external factor is changed by specifying each external factor.

Subsequently, the score impurity calculation unit 1221 calculates the impurity (for example, entropy) of the reward (score) for each external factor with respect to the reward (score) of the extracted learning data. Then, the score impurity calculation unit 1221 extracts the top N external factors having a large impurity value (step S7).

The processing of steps S6 and S7 is executed by the score impurity calculation unit 1221 for M or more device control factor patterns having different division ranges.

Then, the situation constitution element extraction unit 1222 of the situation classification unit 122 refers to the upper N external factors of each device control factor pattern, and the total number of appearances of the external factors appearing in all the extracted device control factor patterns is large, and P pieces are extracted in order and used as a constitution element of the “situation” (Situation) (step S8).

Subsequently, the situation decision tree constitution unit 1223 of the situation classification unit 122 divides the extracted P external factors into predetermined Q range widths for each external factor in the order of frequency, and determines the classes, and configures a decision tree. Then, the situation decision tree constitution unit 1223 defines the final branch point in the constructed decision tree as one “situation” (1Situation) (step S9).

Then, the reinforcement learning unit 120 is strengthened so that the learning data management unit 123 classifies and stores the learning data for each defined “situation” (1Situation) and satisfies the target reward (score) with the learning data by continuing the reinforcement learning, the learning model for each “situation” (1Situation) is updated (step S10). Then, when the reward (score) reaches the target reward (score) as a result of the control of each control target device 5 based on the device control value for each “situation” (1Situation), the process shifts to the operation stage and the process is performed, and ended.

<<Review Process of “Situation” (Situation) Definition>>

Next, the review process of the “situation” (Situation) definition executed by the device control value generation device 1 will be described.

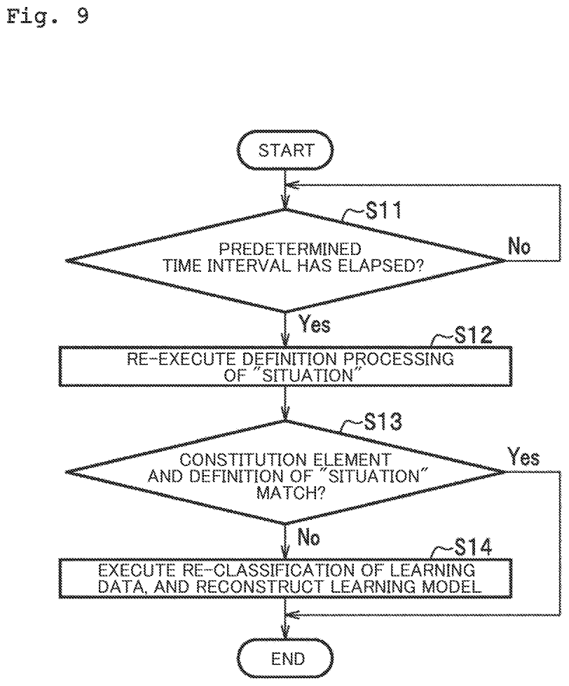

FIG. 9 is a flowchart showing a flow of a review process of the “situation” (Situation) definition executed by the device control value generation device 1 according to the present embodiment.

A review process of this “situation” (Situation) definition is performed at predetermined time intervals in the operation stage. Further, in the initial stage of the start of operation, when there are few variations of external factors, the device control value generation device 1 may be triggered by receiving instruction information from an external management device or the like. In the following, an example of execution at a predetermined time interval will be described.

First, the reinforcement learning unit 120 (situation classification unit 122) of the device control value generation device 1 determines whether or not a predetermined time interval has elapsed (step S11). Then, if the predetermined time interval has not elapsed (step S11→No), the process waits until the predetermined time interval is reached.

On the other hand, when the situation classification unit 122 determines that the predetermined time interval has elapsed (step S11→Yes), the situation classification unit 122 proceeds to the next step S12.

In step S12, the device control value generation device 1 re-executes the definition process of the “situation” (Situation). Specifically, steps S1 to S9 in FIG. 8 are executed to extract the constitution elements of the “situation” (Situation) and to define the “situation” (1Situation).

Then, about the constitution element of “situation” (Situation) and the definition of the “situation” (1Situation), calculated in step S12, the situation classification unit 122 of the device control value generation device 1 determines, whether the constitution element of “situation” (Situation) in operation at the present and the definition of the “situation” (1Situation) match or not (step S13).

If they match (Step S13→Yes), the situation classification unit 122 ends the processing. On the other hand, if they do not match (step S13→No), the reinforcement learning unit 120 reclassifies the learning data according to the constitution elements of the “situation” (Situation) and the definition of the “situation” (1Situation) calculated in step S12, and the reconstruction of the learning model for each “situation” (1 Situation) is executed (step S14).

Specifically, in step S14, the reinforcement learning unit 120 updates the learning model for each newly defined “situation” (1Situation) for each of the redefined the “situations” (1Situation) as with step S10 of FIG. 8, by classifying and storing the learning data, and continuing reinforcement learning so that the learning data meets the target reward (score), by the learning data management unit 123. Then, when the reward (score) reaches the target reward (score) as a result of the control of each control target device 5 based on the device control value for each “situation” (1Situation), the process shifts to the operation stage and the process is performed, and ended.

<<Location Characteristic Update Process>>

Next, the location characteristic update process executed by the continuous disturbance determination unit 125 (situation characteristic change determination unit 1251) of the device control value generation device 1 will be described.

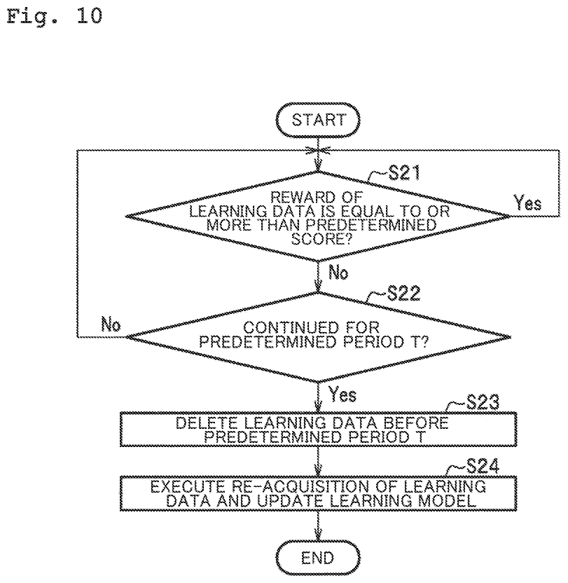

FIG. 10 is a flowchart showing a flow of location characteristic update processing executed by the device control value generation device 1 according to the present embodiment.

First, the continuous disturbance determination unit 125 (situation characteristic change determination unit 1251) of the device control value generation device 1 sets the reward (score) of the learning data stored in the learning data DB 400 by the learning data management unit 123 to the “situation” (Situation). Then, the situation characteristic change determination unit 1251 determines whether or not the reward (score) of the stored learning data is equal to or higher than the predetermined reward (score) (step S21). Further, the predetermined reward (score) may be the same as the target reward (score), or, for example, may be near to or different from the target reward (score).

Then, if the situation characteristic change determination unit 1251 is equal to or higher than a predetermined reward (score) (step S21→Yes), the monitoring of the stored learning data is continued.

On the other hand, if the situation characteristic change determination unit 1251 is not equal to or higher than the predetermined reward (score) (step S21→No), that is, the reward (score) of the stored learning data is less than the predetermined reward (score), after storing this determination time, the process proceeds to the next step S22.

In step S22, the situation characteristic change determination unit 1251 determines whether the situation, in which the rewards (score) of the learning data stored during a predetermined period T (first predetermined period) in the same “situation” (1 Situation) from the determination time stored in step S21, does not satisfy the predetermined reward (score) continues or not.

Here, if the state in which the predetermined reward (score) is not satisfied continues for the predetermined period T (step S22→No), the process returns to step S21 and the process is continued.

On the other hand, when the situation characteristic change determination unit 1251 continues to be in a state where the predetermined reward (score) is not satisfied for the predetermined period T in the same “situation” (1Situation) (step S22→Yes), the process proceeds to the next step S23 by determination of occurring the continuous disturbance.

In step S23, the situation characteristic change determination unit 1251 outputs an instruction to delete all the “situation” (Situation) learning data in the corresponding location before the predetermined period T to the learning data management unit 123.

As a result, the learning data management unit 123 deletes all the learning data of the “situation” (Situation) before the predetermined period T. Then, the reinforcement learning unit 120 reacquires the learning data for each “situation” (1Situation) and updates the learning model (step S24). After updating the learning model, the target reward (score) for the “situation” (1Situation) in which the reward (score) obtained as a result of the control of each control target device 5 by the device control value does not satisfy the target reward (score), and then the process continues to generate learning data and update the learning model until the reward (score) is satisfied, and ends the processing.

<<Location Characteristic Change Monitoring Process>>

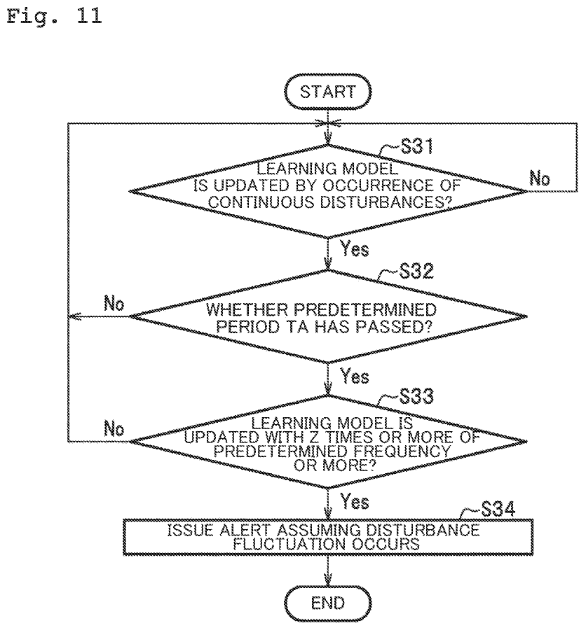

Next, the location characteristic change monitoring process executed by the continuous disturbance determination unit 125 (situation characteristic change monitoring unit 1252) of the device control value generation device 1 will be described. FIG. 11 is a flowchart showing a flow of location characteristic change monitoring processing executed by the device control value generation device 1 according to the present embodiment.

The continuous disturbance determination unit 125 (situation characteristic change monitoring unit 1252) of the device control value generation device 1 monitors whether the situation characteristic change determination unit 1251 has performed the location characteristic update process on the assumption that a continuous disturbance has occurred (see FIG. 10), it is determined whether or not the learning model has been updated (step S31).

Then, if the learning model is not updated by the situation characteristic change determination unit 1251 (step S31→No), the situation characteristic change monitoring unit 1252 continues to monitor the update of the learning model.

On the other hand, when it is determined that the learning model has been updated by the situation characteristic change determination unit 1251 (step S31→Yes), the update time of the learning model is stored, and the process proceeds to the next step S32.

In step S32, the situation characteristic change monitoring unit 1252 determines whether or not the predetermined period Ta (second predetermined period) has passed. The start of this predetermined period Ta may be the time when the situation characteristic change determination unit 1251 first determines that the learning model has been updated, or may be an arbitrarily set time.

Then, if the predetermined period Ta has not passed (step S32→No), the situation characteristic change monitoring unit 1252 records the number (frequency) of updating the learning model and returns to step S31. On the other hand, if the predetermined period Ta has passed (step S32→Yes), the process proceeds to the next step S33.

In step S33, the situation characteristic change monitoring unit 1252 determines whether or not the learning model has been updated due to the occurrence of continuous disturbance at a predetermined frequency Z times (predetermined number of times) or more within a predetermined period Ta.

Then, if the learning model has not been updated Z times or more at a predetermined frequency (step S33→No), the process returns to step S31 and the monitoring of the learning model update is continued.

On the other hand, when the situation characteristic change monitoring unit 1252 determines that the learning model has been updated Z times or more at a predetermined frequency (step S33→Yes), the process proceeds to the next step S34.

In step S34, the situation characteristic change monitoring unit 1252 considers that a disturbance fluctuation due to an unknown external factor has occurred at the corresponding location, increases the types of measuring instruments such as sensors, and manually changes the “situation” (Situation), and an alert prompting the review is issued to an external management device, etc.

<Hardware Configuration>

The device control value generation device 1 according to the present embodiment is realized by, for example, a computer 900 having a configuration as shown in Fig.

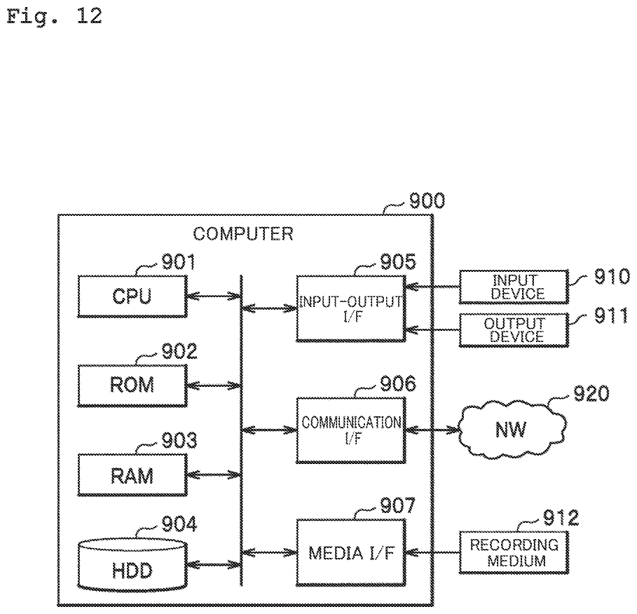

FIG. 12 is a hardware configuration diagram showing an example of a computer 900 that realizes the function of the device control value generation device 1 according to the present embodiment. The computer 900 has a CPU 901, a ROM (Read Only Memory) 902, a RAM 903, an HDD (Hard Disk Drive) 904, an input-output I/F (Interface) 905, a communication I/F 906, and a media I/F 907.

The CPU 901 operates based on a program stored in the ROM 902 or the HDD 904, and is controlled by the control unit 10 of the device control value generation device 1 shown in FIG. 3. The ROM 902 stores a boot program executed by the CPU 901 when the computer 900 is started, a program related to the hardware of the computer 900, and the like.

The CPU 901 controls an input device 910 such as a mouse and a keyboard and an output device 911 such as a display and a printer via the input-output I/F 905. The CPU 901 acquires data from the input device 910 via the input-output I/F 905 and outputs the generated data to the output device 911. A GPU (Graphics Processing Unit) or the like may be used together with the CPU 901 as the processor.

The HDD 904 stores a program executed by the CPU 901, data used by the program, and the like. The communication I/F 906 receives data from another device via a communication network (for example, NW (Network) 920) and outputs the data to the CPU 901, and the communication I/F 906 transfers the data generated by the CPU 901 to another device via the communication network.

The CPU 901 loads the program related to the target processing from the recording medium 912 onto the RAM 903 via the media I/F 907, and executes the loaded program. The CPU 901 loads the program related to the target processing from the recording medium 912 onto the RAM 903 via the media I/F 907, and executes the loaded program. The recording medium 912 is an optical recording medium such as a DVD (Digital Versatile Disc) or PD (Phase change rewritable Disk), a magneto-optical recording medium such as an MO (Magneto Optical disk), a magnetic recording medium, a conductor memory tape medium, a semiconductor memory, or the like.

For example, when the computer 900 functions as the device control value generation device 1 according to the present embodiment, the CPU 901 of the computer 900 realizes the function of the device control value generation device 1 by executing the program loaded on the RAM 903. Further, the data in the RAM 903 is stored in the HDD 904. The CPU 901 reads the program related to the target processing from the recording medium 912 and executes the program. In addition, the CPU 901 may read a program related to the target processing from another device via the communication network (NW 920).

<Effects>

The effects of the device control value generation device and the others according to the present invention will be described below.

A device control value generation device according to the present invention, which generates device control values of a plurality of control target devices 5, is a device control value generation device 1, comprising:
a situation recognition unit 110 that acquires data from each IoT device 3, determines an external factor according to a type of the IoT device, and determines to which division range obtained by dividing an upper limit value and a lower limit value of the determined external factor into a predetermined range the acquired data belongs;
a control value generation unit 121 that generates the device control value according to a value of data of each external factor for each of the division ranges;
a device control unit 130 that transmits the device control value to each control target device;
a score calculation unit 140 for calculating a score indicating a reward obtained from a control result of each control target device;
a learning data management unit 123 that stores each learning data indicated by the device control value and the score as a control result thereof in a learning data DB 400 for each device control factor pattern indicating the device control value corresponding to the division range of each external factor,
a situation classification unit 122 that
acquires the learning data, which is only changed a specified external factor, after one of external factors is specified, and other external factors excluding the external factor, and the device control factor pattern are fixed, from the learning data DB,
extracts the score of the learning data,
calculates a predetermined impurity of the specified external factor by determining which of divided classes divided into predetermined classes according to a level of the score, calculates the impurity in the same device control factor pattern for each of the external factors,
extracts top N external factors having the calculated large impurity,
extracts P external factors in descending order of sum of the number of appearances from the top N external factors extracted in a predetermined M or more device control factor patterns to be a constitution element of a situation as a factor affecting reward variation,
divides extracted each value of P external factors into predetermined Q range widths,
constitutes a decision tree that branches in the order of extraction, constituted decision tree, and
defines each of final branch points in the constructed decision tree as a classification that is one of the situations; and
a learning model management unit 124 that generates a learning model for each of the classifications by performing reinforcement learning so as to satisfy a predetermined reward using the defined learning data for each of the classifications, wherein
the learning model management unit 124 collects learning data by generating the device control value and updates the learning model for each classification, until the predetermined reward is satisfied.

By doing so, the device control value generation device 1 automatically extracts an external factor (constitution element of the situation) that changes the reward (score) in reinforcement learning, and also “situation” (Situation) based on the external factor, and “situation” (1Situation) (classification) can be automatically defined and the learning model can be updated. As a result, it is possible to generate an optimum device control value for responding to a disturbance and satisfying a predetermined reward without human intervention.

Further, in the device control value generation device 1, the situation classification unit 122 is characterized in that the extraction of external factors that are constitution elements of the situation and the definition of classification are executed at predetermined time intervals.

By doing so, the device control value generation device 1 can reduce the frequency of not satisfying a predetermined reward (target reward) at the operation stage.

Further, in the device control value generation device 1, the situation characteristic change determination unit 1251 that determines the location characteristic indicating a factor affecting the unknown or unmeasured reward other than the external factor has changed when a score of learning data in the same classification does not satisfy the predetermined reward continuously for a first predetermined period (predetermined period T) or longer in an operation stage after the score satisfies the predetermined reward, wherein when the situation characteristic change determination unit 1251 determines that the score does not satisfy the predetermined reward continuously for a first predetermined period or longer, the learning data management unit 123 deletes learning data before the first predetermined period, and the learning model management unit 124 updates the learning model for each classification.

In this way, since the device control value generation device 1 can determine the change in the location characteristic, it takes measures against factors that affect the unknown or unmeasured reward in the operation stage without human intervention, and determines the predetermined reward (target reward) can be maintained.

Further, in the device control value generation device 1, when the situation characteristic change determination unit 1251 determines that the location characteristic has changed, and the update of the learning model occurs at a predetermined frequency (predetermined frequency Z times) or more in a second predetermined period (predetermined period Ta), and a situation characteristic change monitoring unit 1252 for issuing an alert on the basis of the fact that disturbance fluctuation due to an unknown external factor occurs.

In this way, the device control value generation device 1 increases the types of measuring instruments of the IoT device 3 and defines the “situation” (Situation) when continuous disturbance fluctuations due to unknown external factors occur, and an alert can be issued to an external management device or the like so as to review it.

A learning model generation device according to the present invention includes
a control value generation unit 121 for generating device control values of a plurality of control target devices 5 for each divided range obtained by dividing an upper limit value and a lower limit value of an external factor indicated by data acquired from each IoT device 3 into predetermined ranges,
a learning data management unit 123 that acquires each learning data indicating the device control value and a score indicating a reward obtained from the control result, and stores a learning data DB for each device control factor pattern indicating the device control value corresponding to the division range of each external factor;
a situation classification unit 122 that
acquires the learning data, which is only changed a specified external factor, after one of external factors is specified, and other external factors excluding the external factor, and the device control factor pattern are fixed, from the learning data DB 400,
extracts the score of the learning data,
calculates a predetermined impurity of the specified external factor by determining which of divided classes divided into predetermined classes according to a level of the score,
calculates the impurity in the same device control factor pattern for each of the external factors,
extracts top N external factors having the calculated large impurity,
extracts P external factors in descending order of sum of the number of appearances from the top N external factors extracted in a predetermined M or more device control factor patterns to be a constitution element of a situation as a factor affecting reward variation,
divides extracted each value of P external factors into predetermined Q range widths,
constitutes a decision tree that branches in the order of extraction, constituted decision tree, and
defines each of final branch points in the constructed decision tree as a classification that is one of the situations; and
a learning model management unit 124 that generates a learning model for each of the classifications by performing reinforcement learning so as to satisfy a predetermined reward using the defined learning data for each of the classifications.

By doing so, the learning model generation device automatically extracts the external factors (constitution elements of the situation that give fluctuations to the reward (score) in reinforcement learning, and also “situations” (1Situation) (classification) based on the external factors, and can be automatically defined and the learning model can be updated. As a result, it is possible to generate an optimum device control value for responding to a disturbance and satisfying a predetermined reward without human intervention.

Note that the present invention is not limited to the embodiment described above, and various modifications can be made by a person of ordinary skill in the art within the technical idea of the present invention.

### REFERENCE SIGNS LIST

1 Device control value generation device
10 Control unit
11 Input-output unit
12 Storage unit
100 Learning model
110 Situation recognition unit
111 External factor measurement unit
112 Location characteristic management unit
113 Situation determination unit
120 Reinforcement learning unit (learning model generation device)
121 Control value generation unit
122 Situation classification unit
123 Learning data management unit
124 Learning model management unit
125 Continuous disturbance determination unit
126 Control value call unit
130 Device control unit
140 Score calculation unit
200 IoT device information DB
300 Control target device information DB
400 Learning data DB
1221 Score impurity calculation unit
1222 Situation constitution element extraction unit
1223 Situation decision tree constitution unit
1251 Situation characteristic change determination unit
1252 Situation characteristic change monitoring unit

1. A device control value generation device, configured to generate device control values of a plurality of control target devices, the device control value generation device comprising a processor configured to perform operations comprising:
acquiring data from each IoT device, determining an external factor according to a type of the IoT device, and determining to which division range obtained by dividing an upper limit value and a lower limit value of the determined external factor into a predetermined range the acquired data belongs;
generating a device control value according to a value of data of each external factor for each of the division ranges;
transmitting the device control value to each control target device;
calculating a score indicating a reward obtained from a control result of each control target device;
storing each learning data indicated by the device control value and the score as a control result thereof in a learning data DB for each device control factor pattern indicating the device control value corresponding to the division range of each external factor;
acquiring the learning data, which is only changed a specified external factor, after one of external factors is specified, and other external factors excluding the external factor, and the device control factor pattern are fixed, from the learning data DB;
extracting the score of the learning data;
calculating a predetermined impurity of the specified external factor by determining which of divided classes divided into predetermined classes according to a level of the score, calculates the impurity in the same device control factor pattern for each of the external factors;
extracting top N external factors having the calculated large impurity;
extracting P external factors in descending order of sum of the number of appearances from the top N external factors extracted in a predetermined M or more device control factor patterns to be a constitution element of a situation as a factor affecting reward variation;
dividing extracted each value of the P external factors into predetermined Q range widths;
constituting a decision tree that branches in the order of extraction;
defining each of final branch points in the constructed decision tree as a classification that is one of the situations; and
generating a learning model for each of the classifications by performing reinforcement learning so as to satisfy a predetermined reward using the defined learning data for each of the classifications,
wherein generating the learning model for each of the classifications comprises: collecting learning data by generating the device control value and by updating the learning model for each classification, until the predetermined reward is satisfied.

2. The device control value generation device according to claim 1, wherein the processor is configured to extract the external factor that is a constitution element of the situation and executes a definition of the classification at predetermined time intervals.

3. The device control value generation device according to claim 1, wherein the processor is configured to determine a location characteristic indicating a factor affecting the unknown or unmeasured reward other than the external factor has changed when a score of learning data in the same classification does not satisfy the predetermined reward continuously for a first predetermined period or longer in an operation stage after the score satisfies the predetermined reward, wherein
when the processor determines that the score does not satisfy the predetermined reward continuously for a first predetermined period or longer, the processor is configured to delete learning data before the first predetermined period, and to update the learning model for each classification.

4. The device control value generation device according to claim 3, wherein the processor is configured to issue an alert, when the learning model is updated more than a predetermined number of times in a second predetermined period due to a determination that the location characteristic has changed, and when disturbance fluctuation due to an unknown external factor occurs.

5. A device control value generation method of a device control value generation device for generating device control values of a plurality of control target devices, the device control value generation method comprising:
acquiring data from each IoT device, determines an external factor according to a type of the IoT device, and determines to which division range obtained by dividing an upper limit value and a lower limit value of the determined external factor into a predetermined range the acquired data belongs;
generating the device control value according to a value of data of each external factor for each of the division ranges;
transmitting the device control value to each control target device;
calculating a score indicating a reward obtained from a control result of each control target device;
storing each learning data indicated by the device control value and the score as a control result thereof in a learning data DB for each device control factor pattern indicating the device control value corresponding to the division range of each external factor;
acquiring the learning data, which is only changed a specified external factor, after one of external factors is specified, and other external factors excluding the external factor, and the device control factor pattern are fixed, from the learning data DB;
extracting the score of the learning data;
calculating a predetermined impurity of the specified external factor by determining which of divided classes divided into predetermined classes according to a level of the score, calculates the impurity in the same device control factor pattern for each of the external factors;
extracting top N external factors having the calculated large impurity,
extracting P external factors in descending order of sum of the number of appearances from the top N external factors extracted in a predetermined M or more device control factor patterns to be a constitution element of a situation as a factor affecting reward variation;
dividing extracted each value of P external factors into predetermined Q range widths;
constituting a decision tree that branches in the order of extraction;
defining each of final branch points in the constructed decision tree as a classification that is one of the situations;
generating a learning model for each of the classifications by performing reinforcement learning so as to satisfy a predetermined reward using the defined learning data for each of the classifications; and
collecting learning data by generating the device control value and updating the learning model for each classification, until the predetermined reward is satisfied.

6. (canceled)

7. A learning model generation device, comprising a processor configured to perform operations comprising:
generating device control values of a plurality of control target devices for each divided range obtained by dividing an upper limit value and a lower limit value of an external factor indicated by data acquired from each IoT device into predetermined ranges;
acquiring each learning data indicating the device control value and a score indicating a reward obtained from the control result, and storing a learning data DB for each device control factor pattern indicating the device control value corresponding to the division range of each external factor;
acquiring the learning data, which is only changed a specified external factor, after one of external factors is specified, and other external factors excluding the external factor, and the device control factor pattern are fixed, from the learning data DB;
extracting the score of the learning data;
calculating a predetermined impurity of the specified external factor by determining which of divided classes divided into predetermined classes according to a level of the score, calculates the impurity in the same device control factor pattern for each of the external factors;
extracting top N external factors having the calculated large impurity;
extracting external factors in descending order of sum of the number of appearances from the top N external factors extracted in a predetermined M or more device control factor patterns to be a constitution element of a situation as a factor affecting reward variation;
dividing extracted each value of P external factors into predetermined Q range widths;
constituting a decision tree that branches in the order of extraction, constituted decision tree;
defining each of final branch points in the constructed decision tree as a classification that is one of the situations; and
generating a learning model for each of the classifications by performing reinforcement learning so as to satisfy a predetermined reward using the defined learning data for each of the classifications.
